(19) United States
(12) Patent Application Publication
(10) Pub. No.: US 2020/0276513 A1
(43) Pub. Date: Sep. 3, 2020

(54) ULTRAFINE BUBBLE GENERATING APPARATUS, ULTRAFINE BUBBLE GENERATING METHOD, AND ULTRAFINE BUBBLE-CONTAINING LIQUID

(71) Applicant: CANON KABUSHIKI KAISHA, Tokyo (JP)

(72) Inventors: Yumi Yanai, Yokohama-shi (JP); Masahiko Kubota, Tokyo (JP); Akitoshi Yamada, Yokohama-shi (JP); Yoshiyuki Imanaka, Kawasaki-shi (JP); Hiroshi Arimizu, Yotsukaido-shi (JP); Hiroyuki Ishinaga, Tokyo (JP); Teruo Ozaki, Yokohama-shi (JP)

(21) Appl. No.: 16/802,677

(22) Filed: Feb. 27, 2020

(30) Foreign Application Priority Data
Feb. 28, 2019 (JP) 2019-036529

(51) Int. Cl. B01B 1/00

(52) U.S. Cl. CPC B01B 1/00

(57) ABSTRACT

In the present invention, a UFB generating apparatus includes: a target concentration setting unit that sets a target concentration of ultrafine bubbles to be contained in a liquid; a driving unit that drives the heating element to cause film boiling in the liquid to generate the ultrafine bubbles; a generation time setting unit that sets a target generation time required for generating a predetermined amount of the liquid having the target concentration; and a controlling unit that controls the driving unit to adjust a generation speed of the ultrafine bubbles in accordance with the target concentration and the target generation time.

### BACKGROUND OF THE INVENTION

### Field of the Invention

The present invention relates to an apparatus for generating ultrafine bubbles smaller than 1.0 μm in diameter, an ultrafine bubble generating method, and ultrafine bubble-containing liquid.

### Description of the Related Art

Recently, there have been developed techniques for applying the features of fine bubbles such as microbubbles in micrometer-size in diameter and nanobubbles in nanometer-size in diameter. Especially, the utility of ultrafine bubbles (hereinafter also referred to as “UFBs”) smaller than 1.0 μm in diameter has been confirmed in various fields.

Japanese Patent No. 6118544 discloses a fine air bubble generating apparatus that generates fine bubbles by ejecting from a depressurizing nozzle a pressurized liquid in which a gas is pressurized and dissolved. Japanese Patent No. 4456176 discloses an apparatus that generates fine bubbles by repeating separating and converging of flows of a gas-mixed liquid with a mixing unit.

Both the apparatuses described in Japanese Patent Nos. 6118544 and 4456176 generate not only the UFBs of nanometer-size in diameter but also relatively a large number of milli-bubbles of millimeter-size in diameter and microbubbles of micrometer-size in diameter. Among the above bubbles, the UFBs are suitable for long-time storage since they are less likely to be affected by the buoyancy and float in the liquid with Brownian motion. However, in the case where the UFBs are generated with the milli-bubbles and the microbubbles, the UFBs are affected by the disappearance of the milli-bubbles and the microbubbles and decreased over time. Given the circumstances, the UFBs with high utility of the desired concentration are demanded to be generated. However, the UFB generating methods disclosed in Japanese Patent Nos. 6118544 and 4456176 have difficulty in controlling the concentration of the UFBs because relatively a large number of the milli-bubbles and the microbubbles are generated.

### SUMMARY OF THE INVENTION

The present invention includes: a heating part including a heating element capable of heating a liquid; a driving unit that drives the heating element to generate film boiling in the liquid to generate ultrafine bubbles; a concentration setting unit that sets a target concentration of the ultrafine bubbles to be contained in the liquid; a generation time setting unit that sets a target generation time required for generating a predetermined amount of the liquid having the target concentration; and a controlling unit that controls the driving unit to adjust a generation speed of the ultrafine bubbles based on the target concentration and the target generation time.

According to the present invention, it is possible to efficiently generate a UFB-containing liquid with high purity, and it is possible to provide a UFB generating apparatus and a UFB generating method capable of controlling a UFB concentration in a liquid.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A to 11C are diagrams illustrating a configuration example of a post-processing unit;

FIG. 12A is a diagram illustrating a schematic configuration of a UFB generating apparatus 1A of an embodiment;

FIG. 12B is a diagram illustrating a schematic configuration of a control system of the UFB generating apparatus 1A of the embodiment;

FIG. 13 is a flowchart describing a processing of generating the UFBs executed in a first embodiment;

FIG. 14 is a diagram illustrating a relationship between a generation time of the UFBs and a UFB concentration;

FIG. 15 is a flowchart illustrating a processing of generating a UFB-containing liquid executed in a first modification of the first embodiment;

FIG. 16 is a flowchart illustrating a processing of generating the UFB-containing liquid executed in a second modification of the first embodiment;

FIG. 17 is a flowchart illustrating a processing of generating the UFB-containing liquid executed in a second embodiment;

FIG. 18 is a flowchart illustrating a processing of generating the UFB-containing liquid executed in a modification of the second embodiment;

FIG. 19 is a diagram illustrating a relationship between the generation time of the UFBs and the UFB concentration; and

FIGS. 20A to 20F are diagrams schematically illustrating configurations of the heating elements in the heating part.

### DESCRIPTION OF THE EMBODIMENTS

### First Embodiment

### Basic Configuration of UFB Generating Apparatus

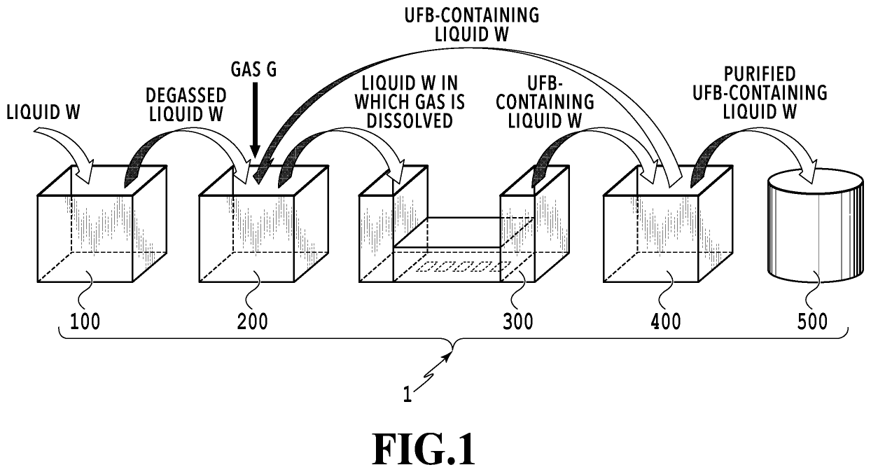

FIG. 1 is a diagram illustrating an example of a basic configuration of an ultrafine bubble generating apparatus (UFB generating apparatus) applicable to the present invention. A UFB generating apparatus 1 of this embodiment includes a pre-processing unit 100, a dissolving unit 200, a T-UFB generating unit 300, a post-processing unit 400, and a collecting unit 500. Each unit performs unique processing on a liquid W such as tap water supplied to the pre-processing unit 100 in the above order, and the thus-processed liquid W is collected as a T-UFB-containing liquid by the collecting unit 500. Functions and configurations of the units are described below. Although details are described later, UFBs generated by utilizing the film boiling caused by rapid heating are referred to as thermal-ultrafine bubbles (T-UFBs) in this specification.

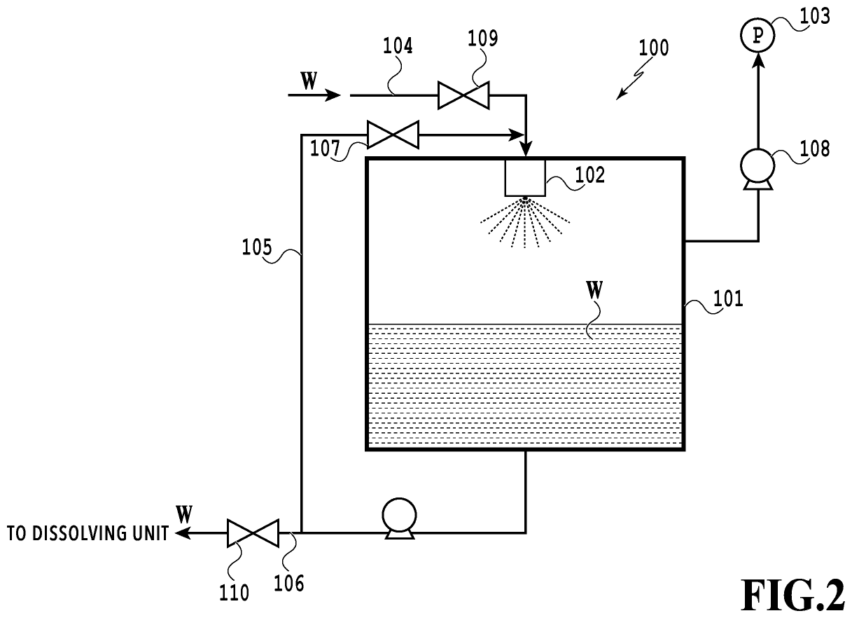

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

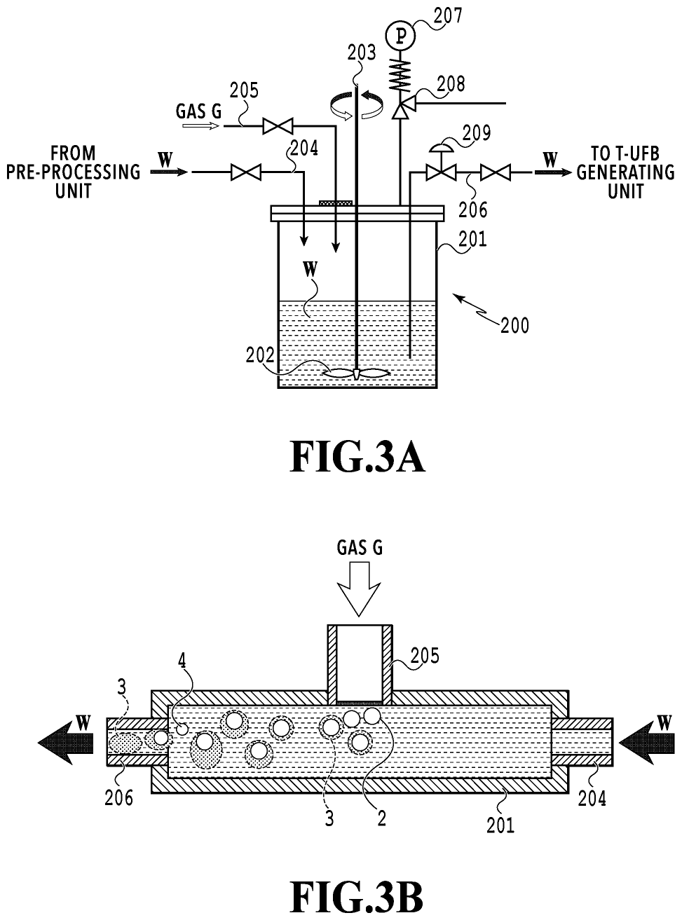

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 for the sake of explanation, such a clear boundary does not actually exist. In addition, in the present invention, a gas that cannot be dissolved completely may be accepted to exist in the form of an air bubble in the liquid.

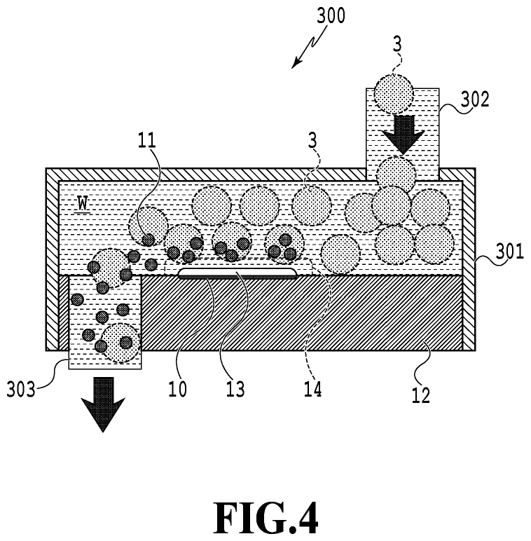

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

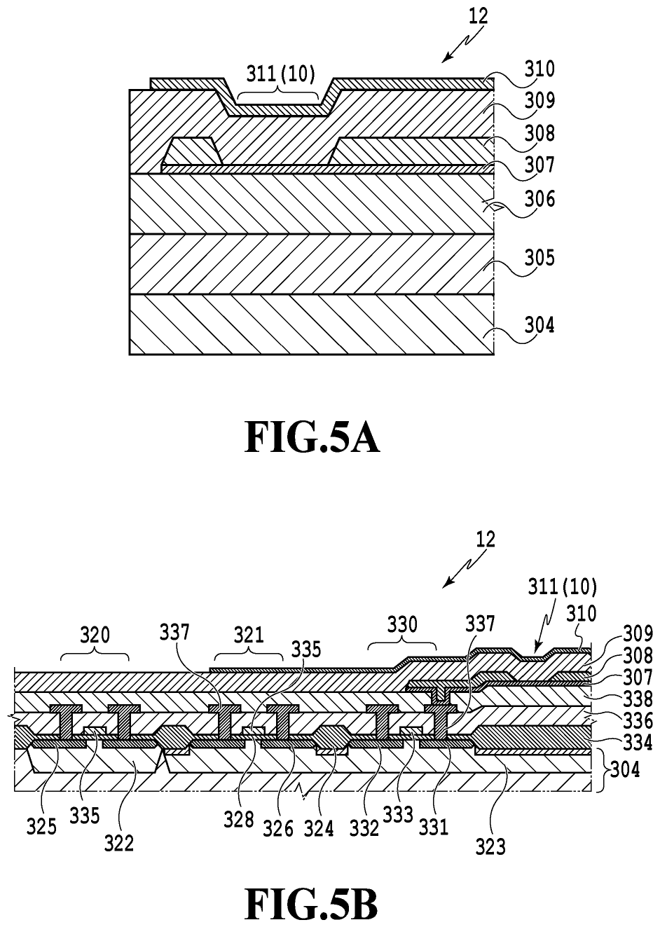

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of Å in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of Å in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

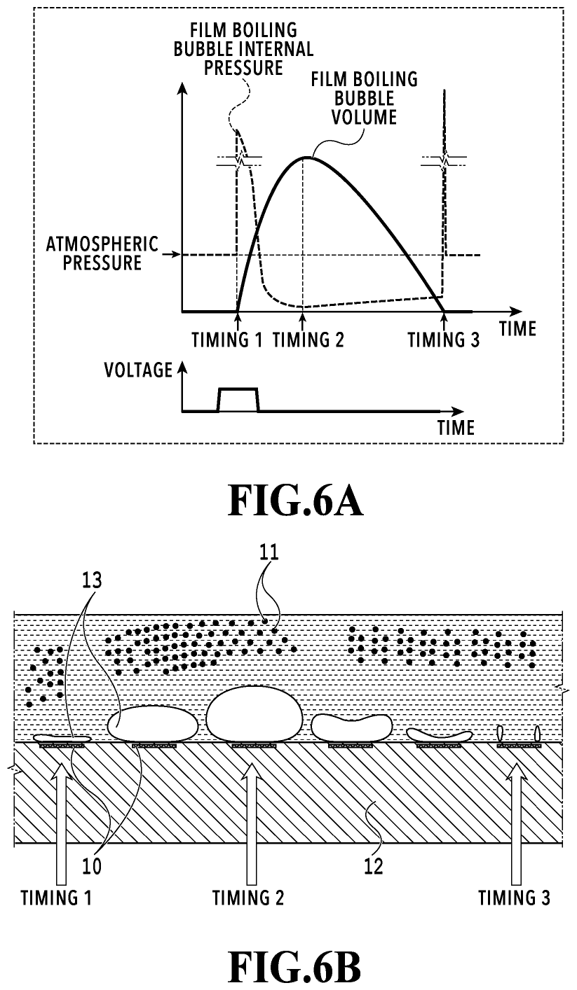

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3)

The generation, expansion, shrinkage, and disappearance of the film boiling bubble 13 as described above are repeated every time a voltage pulse is applied to the heating element 10, and new UFBs 11 are generated each time.

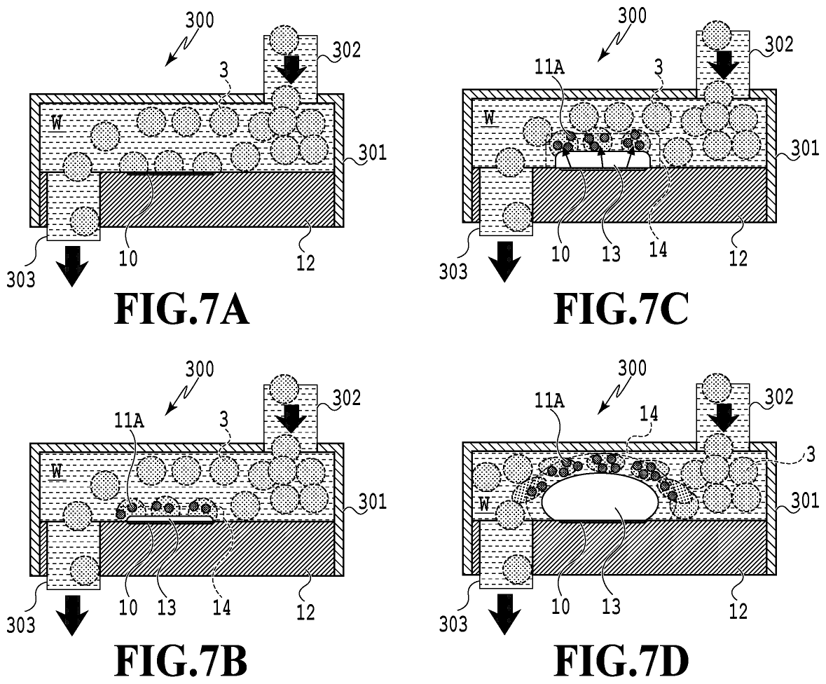

Next, the states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./μsec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

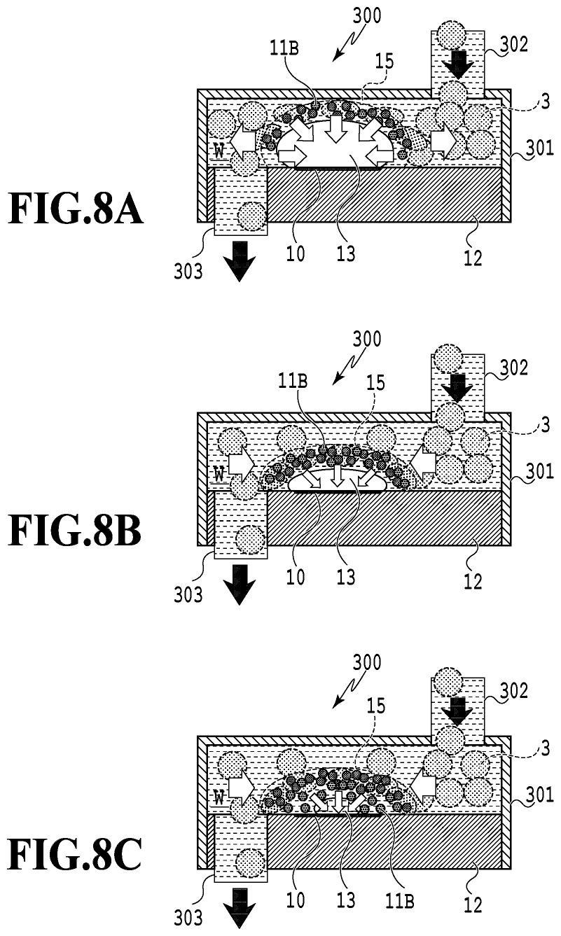

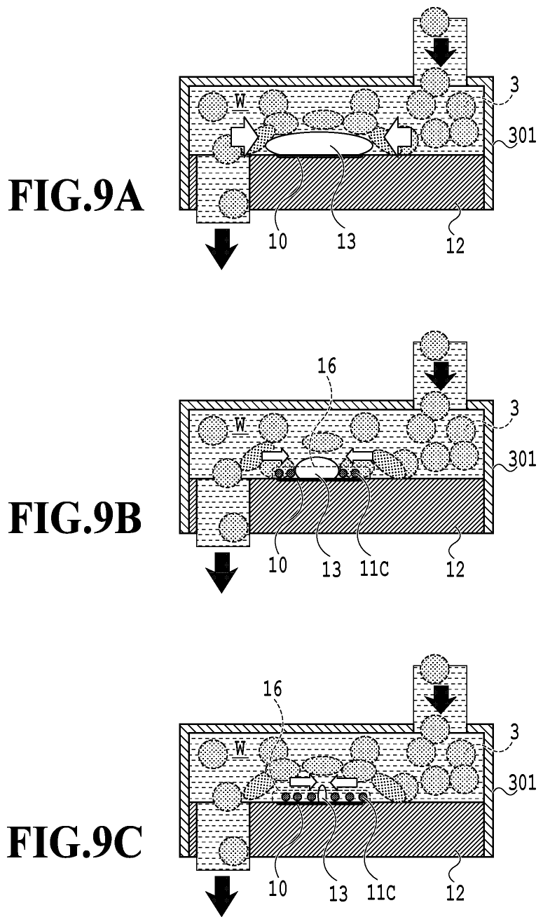

In the shrinking stage of the film boiling bubble 13, there are UFBs generated by the processes illustrated in FIGS. 8A to 8C (second UFBs 11B) and UFBs generated by the processes illustrated in FIGS. 9A to 9C (third UFBs 11C). It is considered that these two processes are made simultaneously.

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

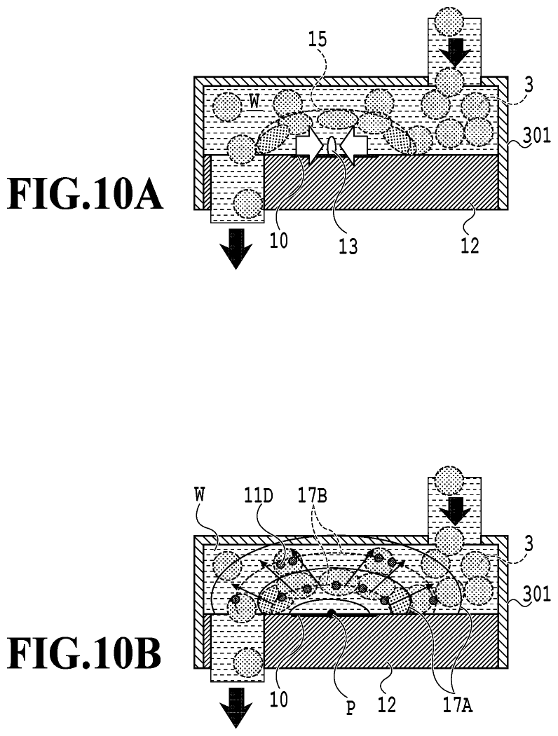

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation of the film boiling bubble 13 by the heat generation of the heating element 10 to the disappearance of the film boiling bubble 13. The first UFBs 11A, the second UFBs 11B, and the third UFBs 11C are generated near the surface of the film boiling bubble generated by the film boiling. In this case, near means a region within about 20 μm from the top surface of the film boiling bubble. The fourth UFBs 11D are generated in a region through which the shock waves are propagated in the case where the air bubble disappears. Although the above example illustrates the stages to the disappearance of the film boiling bubble 13, the way of generating the UFBs is not limited thereto. For example, the UFBs can be generated even in the case where the film boiling bubble 13 does not reach the dissipation because the generated film boiling bubble 13 is communicated with the atmospheric air before the bubble disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure of the liquid and the dissolution properties, the higher the pressure of the liquid, the higher the dissolution properties of the gas, and the lower the pressure, the lower the dissolution properties. In other words, the phase transition to the gas of the gas-dissolved liquid dissolved in the liquid is prompted and the UFBs are generated more easily as the pressure of the liquid is lower. Once the pressure of the liquid becomes lower than normal pressure, the dissolution properties are decreased without stopping, and the generation of the UFBs starts. The pressure dissolution properties are decreased as the pressure decreases, and a number of the UFBs are generated.

Conversely, in the case where the pressure of the liquid increases to be higher than normal temperature, the dissolution properties of the gas are increased, and the generated UFBs are more likely to be liquefied. However, the pressure is sufficiently higher than the atmospheric pressure. Additionally, since the once generated UFBs have a high internal pressure and large gas-liquid interface energy even in the case where the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

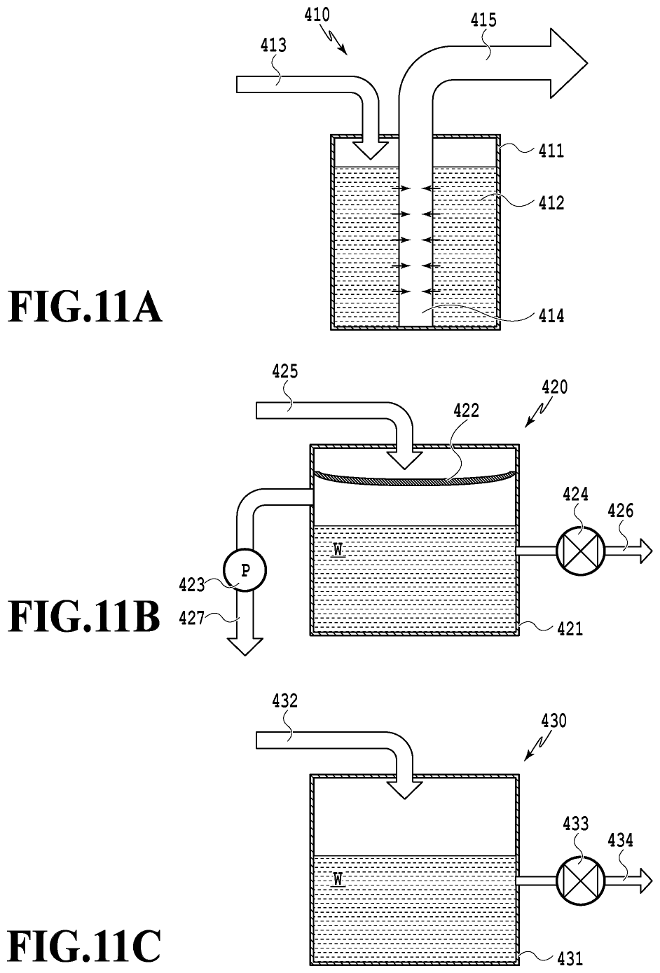

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415. In this process in the present embodiment, not all the inorganic ions contained in the UFB-containing liquid W supplied from the liquid introduction passage 413 need to be removed as long as at least a part of the inorganic ions are removed.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus.

After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434.

Reference to FIG. 1 is made again. The T-UFB-containing liquid W from which the impurities are removed by the post-processing unit 400 may be directly transferred to the collecting unit 500 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of times of circulations through the dissolving unit 200, the T-UFB generating unit 300, and the post-processing unit 400, and it is possible to transfer the UFB-containing liquid W to the collecting unit 500 after a desired concentration of the contained UFBs is obtained.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB method is higher than normal temperature, the collecting unit 500 may be provided with a cooling unit. The cooling unit may be provided to a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The units for removing the impurities as described in FIGS. 11A to 11C may be provided upstream of the T-UFB generating unit 300 or may be provided both upstream and downstream thereof. When the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there is a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously.

### Liquid and Gas Usable for T-UFB-Containing Liquid

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### Effects of T-UFB Generating Method

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

### Specific Usage of T-UFB-Containing Liquid

In general, applications of the ultrafine bubble-containing liquids are distinguished by the type of the containing gas. Any type of gas can make the UFBs as long as an amount of around PPM to BPM of the gas can be dissolved in the liquid. For example, the ultrafine bubble-containing liquids can be applied to the following applications.
A UFB-containing liquid containing air can be preferably applied to cleansing in the industrial, agricultural and fishery, and medical scenes and the like, and to cultivation of plants and agricultural and fishery products.
A UFB-containing liquid containing nitrogen can be preferably applied to not only cleansing application in the industrial, agricultural and fishery, and medical scenes and the like, but to also applications intended to disinfection, sterilization, and decontamination, and environmental cleanup of drainage and contaminated soil, for example.
A UFB-containing liquid containing oxygen can be preferably applied to cleansing application in the industrial, agricultural and fishery, and medical scenes and the like, and to cultivation of plants and agricultural and fishery products.
A UFB-containing liquid containing carbon dioxide can be preferably applied to not only cleansing application in the industrial, agricultural and fishery, and medical scenes and the like, but to also applications intended to disinfection, sterilization, and decontamination, for example.
A UFB-containing liquid containing perfluorocarbons as a medical gas can be preferably applied to ultrasonic diagnosis and treatment. As described above, the UFB-containing liquids can exert the effects in various fields of medical, chemical, dental, food, industrial, agricultural and fishery, and so on.

In each of the applications, the purity and the concentration of the UFBs contained in the UFB-containing liquid are important for quickly and reliably exert the effect of the UFB-containing liquid. In other words, unprecedented effects can be expected in various fields by utilizing the T-UFB generating method of this embodiment that enables generation of the UFB-containing liquid with high purity and desired concentration. Here is below a list of the applications in which the T-UFB generating method and the T-UFB-containing liquid are expected to be preferably applicable.

### (A) Liquid Purification Application

With the T-UFB generating unit provided to a water clarification unit, enhancement of an effect of water clarification and an effect of purification of PH adjustment liquid is expected. The T-UFB generating unit may also be provided to a carbonated water server.
With the T-UFB generating unit provided to a humidifier, aroma diffuser, coffee maker, and the like, enhancement of a humidifying effect, a deodorant effect, and a scent spreading effect in a room is expected.
If the UFB-containing liquid in which an ozone gas is dissolved by the dissolving unit is generated and is used for dental treatment, burn treatment, and wound treatment using an endoscope, enhancement of a medical cleansing effect and an antiseptic effect is expected.
With the T-UFB generating unit provided to a water storage tank of a condominium, enhancement of a water clarification effect and chlorine removing effect of drinking water to be stored for a long time is expected.
If the T-UFB-containing liquid containing ozone or carbon dioxide is used for brewing process of Japanese sake, shochu, wine, and so on in which the high-temperature pasteurization processing cannot be performed, more efficient pasteurization processing than that with the conventional liquid is expected.
If the UFB-containing liquid is mixed into the ingredient in a production process of the foods for specified health use and the foods with functional claims, the pasteurization processing is possible, and thus it is possible to provide safe and functional foods without a loss of flavor.
With the T-UFB generating unit provided to a supplying route of sea water and fresh water for cultivation in a cultivation place of fishery products such as fish and pearl, prompting of spawning and growing of the fishery products is expected.
With the T-UFB generating unit provided in a purification process of water for food preservation, enhancement of the preservation state of the food is expected.
With the T-UFB generating unit provided in a bleaching unit for bleaching pool water or underground water, a higher bleaching effect is expected.
With the T-UFB-containing liquid used for repairing a crack of a concrete member, enhancement of the effect of crack repairment is expected.
With the T-UFBs contained in liquid fuel for a machine using liquid fuel (such as automobile, vessel, and airplane), enhancement of energy efficiency of the fuel is expected.

### (B) Cleansing Application

Recently, the UFB-containing liquids have been receiving attention as cleansing water for removing soils and the like attached to clothing. If the T-UFB generating unit described in the above embodiment is provided to a washing machine, and the UFB-containing liquid with higher purity and better permeability than the conventional liquid is supplied to the washing tub, further enhancement of detergency is expected.
With the T-UFB generating unit provided to a bath shower and a bedpan washer, not only a cleansing effect on all kinds of animals including human body but also an effect of prompting contamination removal of a water stain and a mold on a bathroom and a bedpan are expected.
With the T-UFB generating unit provided to a window washer for automobiles, a high-pressure washer for cleansing wall members and the like, a car washer, a dishwasher, a food washer, and the like, further enhancement of the cleansing effects thereof is expected.
With the T-UFB-containing liquid used for cleansing and maintenance of parts produced in a factory including a burring step after pressing, enhancement of the cleansing effect is expected.
In production of semiconductor elements, if the T-UFB-containing liquid is used as polishing water for a wafer, enhancement of the polishing effect is expected. Additionally, if the T-UFB-containing liquid is used in a resist removal step, prompting of peeling of resist that is not peeled off easily is enhanced.
With the T-UFB generating unit is provided to machines for cleansing and decontaminating medical machines such as a medical robot, a dental treatment unit, an organ preservation container, and the like, enhancement of the cleansing effect and the decontamination effect of the machines is expected. The T-UFB generating unit is also applicable to treatment of animals.

### (C) Pharmaceutical Application

If the T-UFB-containing liquid is contained in cosmetics and the like, permeation into subcutaneous cells is prompted, and additives that give bad effects to skin such as preservative and surfactant can be reduced greatly. As a result, it is possible to provide safer and more functional cosmetics.
If a high concentration nanobubble preparation containing the T-UFBs is used for contrasts for medical examination apparatuses such as a CT and an MRI, reflected light of X-rays and ultrasonic waves can be efficiently used. This makes it possible to capture a more detailed image that is usable for initial diagnosis of a cancer and the like.
If high concentration nanobubble water containing the T-UFBs is used for a ultrasonic wave treatment machine called high-intensity focused ultrasound (HIFU), the irradiation power of ultrasonic waves can be reduced, and thus the treatment can be made more non-invasive. Particularly, it is possible to reduce the damage to normal tissues.
It is possible to create a nanobubble preparation by using high concentration nanobubbles containing the T-UFBs as a source, modifying a phospholipid forming a liposome in a negative electric charge region around the air bubble, and applying various medical substances (such as DNA and RNA) through the phospholipid.
If a drug containing high concentration nanobubble water made by the T-UFB generation is transferred into a dental canal for regenerative treatment of pulp and dentine, the drug enters deeply a dentinal tubule by the permeation effect of the nanobubble water, and the decontamination effect is prompted. This makes it possible to treat the infected root canal of the pulp safely in a short time.

### Characteristic Configuration

Next, a characteristic configuration of the first embodiment of the present invention is described.

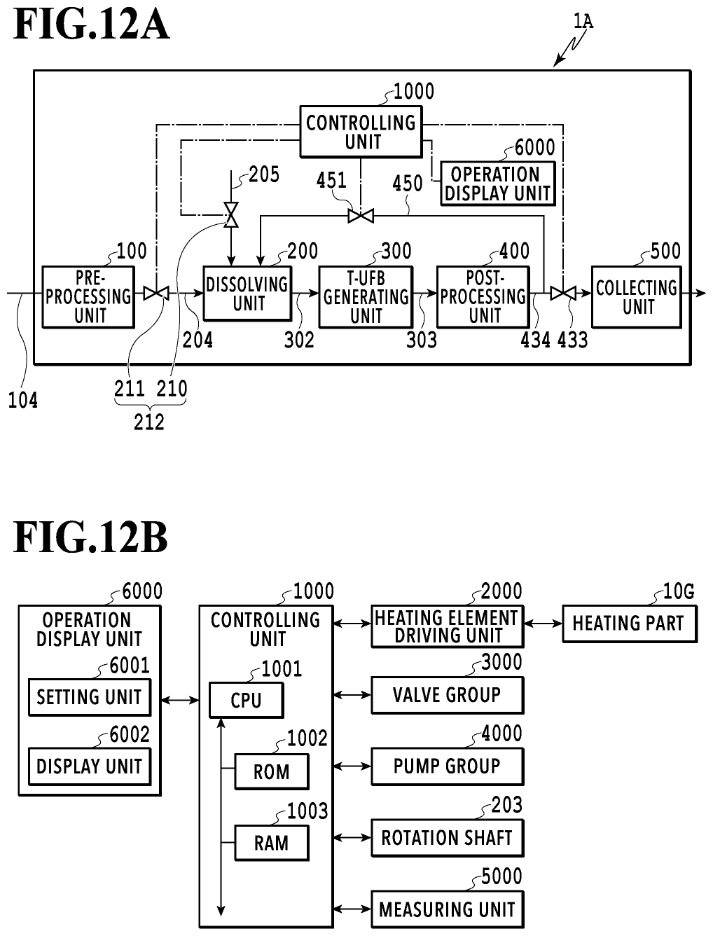

FIG. 12A is a diagram illustrating a schematic configuration of a UFB generating apparatus 1A of this embodiment. Similar to the one illustrated in the above-described basic configuration, the UFB generating apparatus 1A illustrated in FIG. 12A includes the pre-processing unit 100, the dissolving unit 200, the T-UFB generating unit 300, the post-processing unit 400, and the collecting unit 500. However, the UFB generating apparatus 1A of this embodiment is provided with a reflux flow route 450 that introduces the UFB-containing liquid generated by the post-processing unit 400 to the dissolving unit 200. Specifically, in the liquid introduction passage 434 of the post-processing unit 400 (see FIG. 11C), one end of the reflux flow route 450 is connected to the upstream side of the discharge valve 433, and the other end of the reflux flow route 450 is connected to the dissolving container 201 of the dissolving unit 200 (see FIG. 3). Additionally, the reflux flow route 450 is provided with a circulation valve 451 that switches the route 450 between communication and interruption.

Additionally, in FIG. 12A, 210 indicates a gas introduction valve provided in the gas introduction passage 205 of the dissolving unit 200, and 211 indicates a liquid introduction valve provided in the liquid introduction passage 204 of the dissolving unit 200. In the following descriptions, these valves 210 and 211 are also referred to together as an introduction valve 212. The introduction valve 212, the discharge valve 433, and the circulation valve 451 are controlled by a controlling unit 1000 described later.

In this embodiment, it is possible to form a circulation route by closing the introduction valve 212 and the discharge valve 433 and opening the circulation valve 451. Specifically, it is possible to form a circulation route in which the liquid in the dissolving unit 200 is put back again to the dissolving unit 200 through the T-UFB generating unit 300, the post-processing unit 400, and the reflux flow route 450.

FIG. 12B is a diagram illustrating a schematic configuration of a control system of the UFB generating apparatus 1A of this embodiment. In FIG. 12B, the controlling unit 1000 includes a CPU 1001, a ROM 1002, a RAM 1003, and so on, for example. The CPU 1001 functions as a controlling unit that has centralized control of the overall UFB generating apparatus 1A. The ROM 1002 stores a control program executed by the CPU 1001, a predetermined table, and other fixed data. The RAM 1003 includes a region for storing various kinds of input data temporarily, a working region for executing processing by the CPU 1001, and the like. An operation display unit 6000 includes a setting unit 6001 functioning as a setting unit that allows a user to perform various operations for setting the concentration of the generated UFBs, the UFB generation time, and the like, and a display unit 6002 as a display unit that displays a time required for generating the UFB-containing liquid and a state of the apparatus. The setting unit 6001 in this operation display unit 6000 functions as a target concentration setting unit that sets a target concentration of the UFBs and also functions as a generation time setting unit that sets a target generation time of the UFBs.

The controlling unit 1000 controls a heating element driving unit (driving unit) 2000 that controls driving of the multiple heating elements 10 in a heating part 10G provided on the element substrate 12. The heating element driving unit 2000 applies a driving pulse corresponding to a control signal from the CPU 1001 to each of the multiple heating elements 10 in the heating part 10G. Each heating element 10 generates heat according to a voltage, a frequency, a pulse width, and the like of the applied driving pulse.

The controlling unit 1000 controls a valve group 3000 including the valves provided in the units. The valve group 3000 also includes the above-described introduction valve 212, discharge valve 433, circulation valve 451, and so on. In addition, the controlling unit 1000 also controls a pump group 4000 including various pumps provided in the UFB generating apparatus and the rotation shaft 203 provided in the dissolving unit 200. As described above in the basic configuration, the T-UFB generating unit 300 is provided with a measuring unit that performs measuring to estimate the UFB concentration of the UFB-containing liquid being generated, and the thus-measured value is inputted to the controlling unit 1000. Other configurations are similar to that of the above-described UFB generating apparatus 1, and the redundant descriptions are omitted.

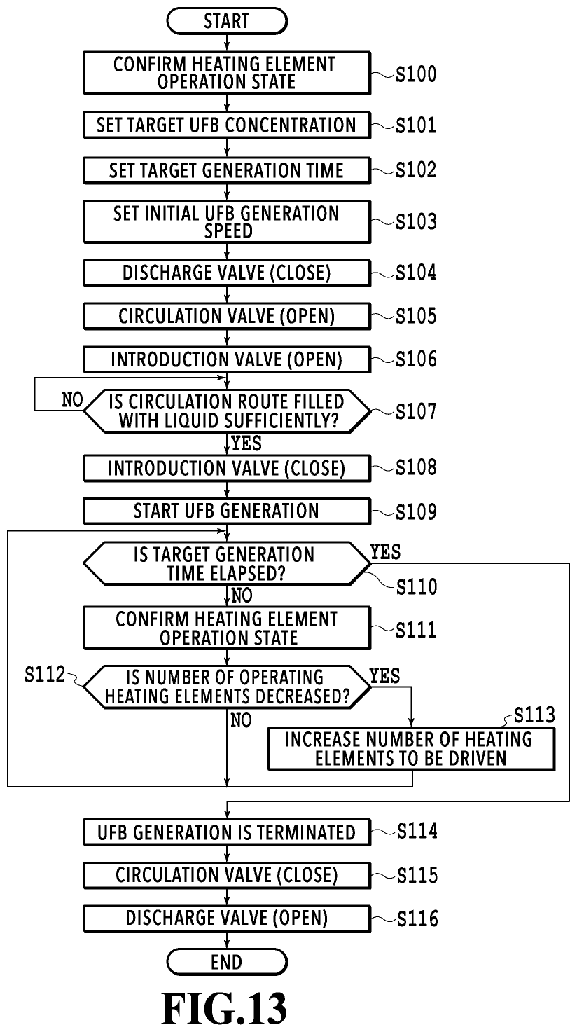

Next, operations of generating the UFBs executed in the first embodiment are described with reference to the flowchart in FIG. 13. The series of processings shown in FIGS. 13, 15, 16, 17, and 18 used for the following descriptions are performed with the CPU 1001 decompressing program codes stored in the ROM 1002 to the RAM 1003 and executing the program codes. Alternatively, a part of or all the functions in FIGS. 13, 15, 16, 17, and 18 may be implemented by hardware such as an ASIC and an electronic circuit. The sign “S” in the description of each processing means a step in the description of the processing.

First, in S100, a confirmation processing for estimating the number of the heating elements that are in the state capable of properly heating the liquid in the heating part 10G, or the heating elements that are in the state capable of generating the UFBs (hereinafter, also referred to as operating heating elements) is executed. A method of confirming the operation state of the heating elements 10 includes a method of measuring changes in temperature around the heating elements 10 being driven, a method of measuring a bubbling sound, a method of measuring a state of energization to the heating elements 10, and the like, and any of them may be used. The number of the heating elements to be used within the range of the operating heating elements confirmed by the confirmation processing is set as a driving condition. In order to set the number of the heating elements to be used, it is possible to select a method of setting the number of the heating elements determined in advance within the range of the number of the operating heating elements by the CPU 1001, a method of performing the setting by the user through the setting unit 6001, or the like, as necessary.

Thereafter, in S101, the target UFB concentration of the T-UFB-containing liquid to be generated (hereinafter, simply referred to as a UFB-containing liquid) is set. The target UFB concentration is set by the user through the setting unit 6001. Next, in S102, the target generation time for generating a predetermined amount of the UFB-containing liquid having the target UFB concentration is set. A method of setting the target generation time includes a method of calculating and setting the target generation time based on the number of the heating elements to be used, the target UFB concentration, and the amount of the UFB-containing liquid to be generated by the CPU 1001 and the like, a method of setting the target generation time according to the input by the user through the setting unit 6001, and the like. In this embodiment, the CPU 1001 calculates and sets the target generation time based on the number of the heating elements to be used, the target UFB concentration set by the processing in S101, and the amount of the UFB-containing liquid to be generated. Thus, in this embodiment, the CPU 1001 functions as the generation time setting unit.

Next, in S103, an initial generation speed of the UFBs (hereinafter, referred to as an initial generation speed) is set. A specific example of a method of calculating and setting the initial generation speed is described below.

In this case, the number of the UFBs to be generated (the UFB concentration) per 1 mL is 100 million pieces/mL. The amount of the UFB-containing liquid to be generated is 1 L. The target UFB generation time in this case is expressed by:

target UFB generation time=1.0e2(seconds)(=1.0×10²).

Meanwhile, the initial generation speed is expressed by the following expression and is set in S103:

$$initial generation speed = ( 1.0 e 8 ( pieces \text{/} mL ) \times 1.0 e 3 ( mL ) ) / 1.0 e 2 ( seconds ) = 1.0 e 9 ( pieces \text{/} seconds ) 1 billion per second .$$

In this embodiment, the number of the heating elements to be used is determined as below based on the target UFB concentration set by the user, the calculated target UFB generation time, and the initial generation speed.

Now, assuming that, the UFB-containing liquid of 1 L (liter) having the target UFB concentration is generated at the initial generation speed in the target UFB generation time (100 seconds), with the number of times of driving the heating elements (drive frequency) per second being 10 kHz, for example. In this case, the number of the heating elements to be required (first operation number) is set as follow:

$$number of heating elements = 1.0 e 9 ( pieces \text{/} seconds ) / ( 10 \times ( 1.0 e 4 ) ) = 1.0 e 4 ( = 1.0 \times {10}^{4} ) ( pieces ) .$$

In the above example, the number of the heating elements used for the UFB generation is 10,000 pieces, as described above. It is expected that the UFBs are generated under the above-described condition by the later-described UFB generating processing. Thus, the number of the heating elements as a driving target that are driven by the heating element driving unit 2000 is fixed to 10,000 pieces in the initial state.

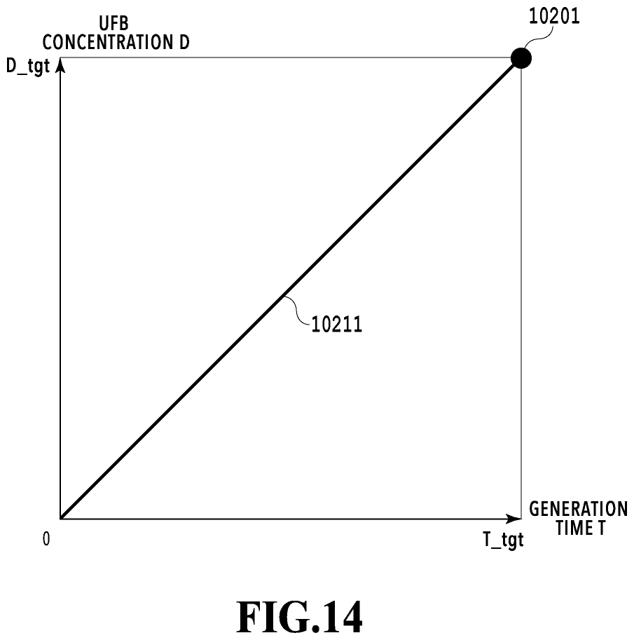

The relationship between the UFB concentration of the UFB-containing liquid to be generated and the UFB generation time T is described with reference to FIG. 14. A point 10201 illustrated in FIG. 14 indicates that the concentration of the UFB-containing liquid to be generated is expected to reach a target UFB concentration D_tgt (=1.0e8 pieces/mL) at the time point after a lapse of a target generation time T_tgt (=100 seconds). A straight line 10211 illustrated in FIG. 14 indicates an estimated value of the UFB concentration increasing over the lapse of the generation time. Hereinafter, the estimated value of the UFB concentration on the straight line 10211 is called a progress concentration.

In this embodiment, in the case of generating the UFB-containing liquid having the target UFB concentration in the target generation time, the CPU 1001 controls the driving of the heating elements 10 by the heating element driving unit 2000 to maintain the UFB generation speed at a constant speed (initial setting speed). That is, driving of the heating elements 10 is controlled to make the incline of the straight line 10211 illustrated in FIG. 14 constant.

Subsequently, advance preparation for generating the UFBs is made from S104. First, the discharge valve 433 is closed in S104, and the circulation valve 451 is opened in S105. Next, the introduction valve 212 (the gas introduction valve 210 and the liquid introduction valve 211 (see FIG. 12)) is closed. Thereafter, the introduction valve 212 is opened in S106. Thus, the circulation route from the dissolving unit 200 to come back again to the dissolving unit 200 through the T-UFB generating unit 300, the post-processing unit 400, and the reflux flow route 450 is formed, and the liquid is supplied to this circulation route.

Thereafter, it is determined whether the above-described circulation route is filled with the liquid in S107, and if the determination result is NO, the supplying of the liquid to the circulation route continues. Thereafter, if the determination result in S107 is YES, the introduction valve 212 is closed in S108. Thus, the advance preparation for generating the UFBs is completed.

Subsequently, in S109, a predetermined number (10,000 pieces, in this example) of the heating elements provided in the heating part 10G are driven to start the UFB generation. The driving of the heating elements is performed by the CPU 1001 controlling the heating element driving unit 2000.

Next, in S110, it is determined whether the target generation time set in S102 elapsed. If the determination result is NO, or if the target generation time has not elapsed yet, the process proceeds to S111.

In S111, the heating elements to be used for generating the UFBs are driven, and the driving state of the heating elements being driven (driving heating elements), that is, the number of the heating elements performing the heating function (operating heating elements) is estimated. The method of confirming the operation state of the heating elements includes the method of measuring changes in temperature around the heating elements being driven, the method of measuring the bubbling sound, the method of measuring a state of energization to the heating elements, and the like, and any of them may be used.

As described above, in this embodiment, after generating the UFBs, the operating heating elements performing the heating function among the heating elements used for generating the UFBs are confirmed. This is because of the following reason.

In this embodiment, basically the UFBs are generated by deriving the number of times of driving the heating elements based on the conditions set before starting the UFB generation such as the target UFB concentration, the target generation time, and the initial UFB generation speed. Thus, in the case where all the heating elements being used are the operating heating elements having the heating function that enables the UFB generation, it is possible to generate a predetermined amount of the UFB-containing liquid having the target UFB concentration by managing the target generation time. However, the multiple heating elements actually provided in the heating part 10G include the one that is damaged by heating, bubbling, and bubble disappearance and loses the heating function. In the case where such a non-operating heating element is generated, there is a possibility that the number of the UFBs to be generated is decreased and the expected UFB concentration cannot be obtained. To deal with this, in this embodiment, the number of the operating heating elements is maintained constant by estimating the number of the operating heating elements in the processing of confirming the operation of each heating element and performing the processings of S112 and S113 described later.

In S112, it is determined whether the number of the operating heating elements confirmed in S111 is decreased from the number of the operating heating elements confirmed in S100. Specifically, it is determined whether the number of the operating heating elements (the number of first operating heating elements) after starting the UFB generation (after driving the heating elements) is decreased from the number of the operating heating elements before the UFB generation (before driving the heating elements). In the determination in S112 performed while repeating the processings of S110 to S113, it is determined whether the number of the operating heating elements confirmed by the processing of confirming the operation state of the heating elements this time is decreased from the number of the operating heating elements confirmed by the confirmation processing last time. If the determination result is YES, the process proceeds to S113, and if the determination result is NO, the process returns to S110, and the processing continues.

In S113, the number of the driving target heating elements (driving heating elements) is increased by adding based on the number of the operating heating elements confirmed in S111. The number of the driving heating elements to be added is calculated based on the number of the operating heating elements confirmed in S111 and the number of the operating heating elements confirmed in S100. That is, the difference between the number of the operating heating elements confirmed in S111 and the number of the operating heating elements confirmed in S100 is the number of the driving heating elements to be added. Thus, the generation speed of the heating elements is maintained constant. In the case where the added driving heating elements are the non-operating heating elements, the decreased number of the operating heating elements is confirmed in the next processing of confirming the operation state of the heating elements (S111), and the driving heating elements are added again. With this processing, the number of the operating heating elements eventually coincides with the number of the operation heating elements confirmed in S100.

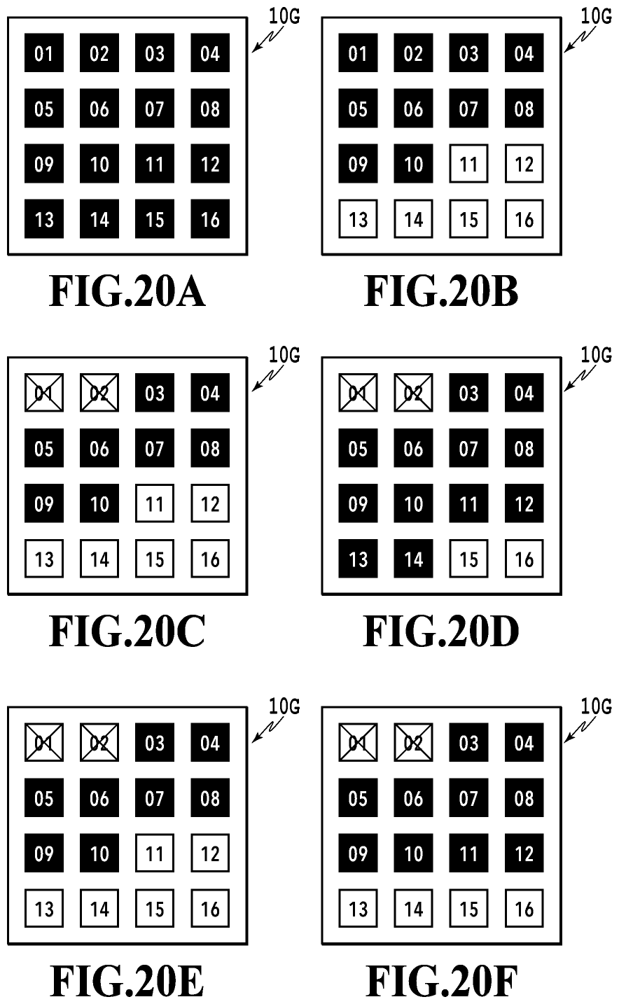

The processing of adding the operating heating elements is described in detail with reference to FIGS. 20A to 20D. FIGS. 20A to 20F are a diagram schematically illustrating configurations of the heating elements in the heating part 10G. For the sake of simple descriptions, an example where 16 heating elements (heating elements of numbers 1 to 16) in total are provided such that four heating elements are each arranged vertically and horizontally in the heating part 10G is illustrated. In FIGS. 20A to 20F, the heating elements being operated (operating heating elements) are colored in black while the heating elements being not operated are colored in white. The heating elements that lost the heating function are indicated by the × sign.

As described above, in this embodiment, the number of the heating elements to be driven and the sequential numbers thereof are set in the initial state by setting the target UFB concentration, the target generation time, and the initial UFB generation speed. FIG. 20B illustrates the heating elements of numbers 1 to 10 that are the heating elements as the driving target in the initial state, and the heating elements of numbers 11 to 16 that are the heating elements not as the driving target and in a reserve state (non-operating heating elements).

If it is confirmed that two heating elements (the heating elements of numbers 01 and 02 illustrated in FIG. 20C) are not operated in the heating element operation confirmation processing in S111, in this case, two of the heating elements in the reserve state are added to be driven in S113. FIG. 20F illustrates the state where the two heating elements (the heating elements of numbers 11 and 12) are added to be driven, and those heating elements are operated normally. In this case, there are ten operating heating elements (numbers 03 to 12) and four heating elements (numbers 13 to 16) in the reserve state.

The processings of S111 to S113 described above are repeated until the target generation time elapse, and after a lapse of the target generation time, the process proceeds to S114, and the UFB generating processing is terminated.

Thereafter, the circulation valve 451 is closed in S115, and the discharge valve 433 is opened in S116. Thus, the UFB-containing liquid generated through the T-UFB generating unit 300 and the post-processing unit 400 is discharged to the collecting unit 500. With the above processing, a series of the processings of generating the UFB-containing liquid is terminated.

As described above, in this embodiment, it is possible to generate the UFB-containing liquid having the target UFB concentration in the target generation time by making the number of the operating heating elements constant to maintain the generation speed constant, the number of the operating heating elements being one of the conditions for driving the heating elements.

### First Modification of First Embodiment

The first embodiment shows the example where the UFB-containing liquid having the target UFB concentration is generated in the target generation time while maintaining the UFB generation speed constant by controlling the number of the heating elements used for generating the UFBs (operating heating elements). However, the method of generating the UFB-containing liquid having the target UFB concentration in the target generation time while maintaining the UFB generation speed constant is not limited to the method described in the above first embodiment. For example, like the later-described first modification, it is also possible to maintain the generation speed constant by controlling the number of times of driving the operating heating elements for generating the UFBs per second, that is, the drive frequency as one of the conditions for driving the heating elements.

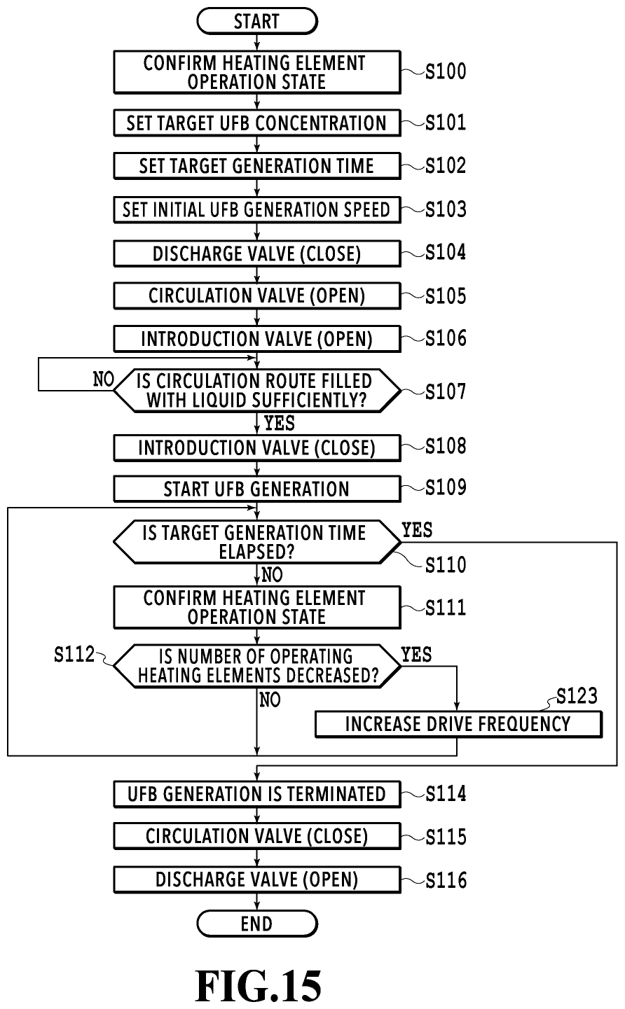

Hereinafter, the processing of generating the UFB-containing liquid executed in this modification is described with reference to the flowchart in FIG. 15. Processings of S100 to S111 and processings of S114 to S116 in FIG. 15 are similar to the processings of S100 to S111 and processings of S114 to S116 in FIG. 13, and the redundant descriptions are omitted.

In S112, similar to the first embodiment, it is determined whether the number of the operating heating elements confirmed in S111 is decreased from the number of the operating heating elements confirmed in S100 or is decreased from the number of times of the heating confirmed by the processing of confirming the operation state of the heating elements last time. If the determination result is YES, the process proceeds to S123, and if the determination result is NO, the process returns to S110 and the processing continues. In S123, the drive frequency of each operating heating element is increased so as to maintain the UFB generation speed constant even if the decrease in the number of the operating heating elements is confirmed in S111.

Table 1 shows an example of calculations indicating that how does the drive frequency required to accomplish the number of the target UFBs in the target generation time (the number of times of heating per second) change in accordance with the number of the operating heating elements in this example.

TABLE 1

| target UFB | 100,000,000 pieces/ml | | | | |
|---|---|---|---|---|---|
| concentration | | | | | |
| target generation | 1,000 ml | | | | |
| amount of target | | | | | |
| UFB-containing liquid | | | | | |
| required number of UFBs | 100,000,000,000 pieces | | | | |
| number of UFBs | 10 pieces/heating | | | | |
| generated in each | | | | | |
| driving of one | | | | | |
| heating element | | | | | |
| number of times | 10,000 | 12,500 | 20,000 | 40,000 | 100,000 |
| driving per second | | | | | |
| number of operating | 10,000 | 8,000 | 5,000 | 2,500 | 1,000 |
| heating elements | | | | | |
| number of UFBs | 1,000,000,000 | 1,000,000,000 | 1,000,000,000 | 1,000,000,000 | 1,000,000,000 |
| generated per second | | | | | |
| estimated seconds | 100 | 100 | 100 | 100 | 100 |
| required to reach | | | | | |
| target number of UFBs | | | | | |
| estimated time [hour] | 0 | 0 | 0 | 0 | 0 |
| estimated time [minute] | 1 | 1 | 1 | 1 | 1 |
| estimated time [second] | 40 | 40 | 40 | 40 | 40 |

As shown in Table 1, it can be seen that the T-UFB method allows drive frequency of each operating heating element to be increased even in the case where the number of the operating heating elements is decreased, and it is possible to generate the UFB-containing liquid of a target liquid amount having the target UFB concentration in the target generation time. The target generation time means estimated seconds required to reach the target number of the UFBs to be generated.

After the drive frequency of the heating element is increased in S123, the process returns to S110, and the processing continues. Then, after a lapse of the target generation time, if the determination result in S110 is YES, the process proceeds to S114, and the UFB generating processing is terminated. Thereafter, similar to the first embodiment, the processings of S114 to S116 are executed, and the thus-generated UFB-containing liquid is discharged to the collecting unit 500. With the above processing, a series of the processings of generating the UFB-containing liquid is terminated.

### Second Modification of First Embodiment

Next, a second modification of the first embodiment is described. The above-described first embodiment shows the example where the control for increasing the number of the operating heating by adding is performed as a measure against the case where the heating elements to be driven include the one that lost the heating function, and the first modification shows the example where the control for increasing the drive frequency of the operating heating element. In contrast, in this modification, in the case where the heating elements to be driven include the one that lost the heating function, the control for increasing the number of the driving heating elements by adding, the control for increasing the drive frequency, and the control for increasing the bubbling power per driving of the heating elements are performed simultaneously.

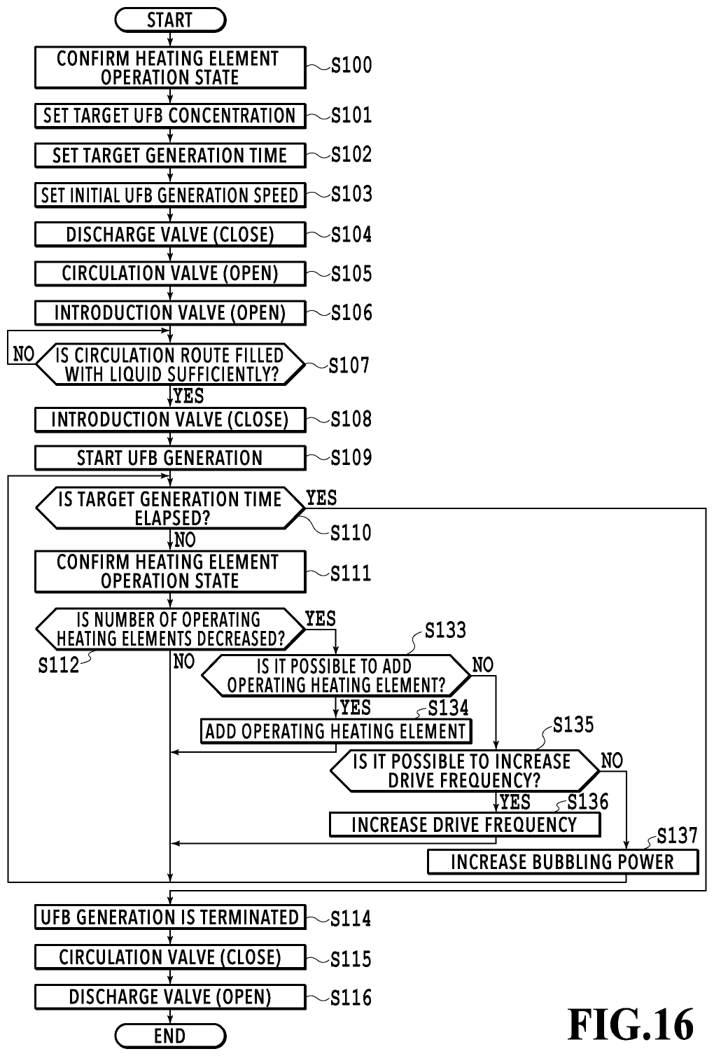

Hereinafter, the processing of generating the UFB-containing liquid executed in this modification is described with reference to the flowchart in FIG. 16. Processings of S100 to S111 and processings of S114 to S116 in FIG. 16 are also similar to the processings of S100 to S111 and processings of S114 to S116 in FIG. 13, and the redundant descriptions are omitted.

In S112, similar to the first embodiment, it is determined whether the number of the operating heating elements confirmed in S111 is decreased from the number of the operating heating elements confirmed in S100 or is decreased from the number of times of the heating confirmed by the processing of confirming the operation state of the heating elements last time (S111). If the determination result is YES, it is determined whether it is possible to add the operating heating elements in S133. In the case where there are available heating elements (operating heating elements) among the heating elements provided in the heating part 10G of the apparatus (in the case where the number of the heating elements provided in the heating part 10G is smaller than the number of the initial operating heating elements), the processing of adding the operating heating elements is performed in S134.

On the other hand, if it is determined that it is impossible to add the operating heating elements based on the determination in S133, and if the initial number of the operating heating elements is equal to the number of the heating elements provided in the heating part 10G, for example, the process proceeds to S135. In S135, it is determined whether it is possible to increase the drive frequency. If it is determined that it is possible to increase the drive frequency, the drive frequency is increased so that the UFB-containing liquid of the target generation amount having the target UFB concentration can be generated in the target generation time using the number of the operating heating elements that is set currently, as shown in Table 1 (S136). After the drive frequency is increased, the process returns to S110, and the processing continues.

If it is determined that it is impossible to increase the drive frequency in S136, that is, if the currently set drive frequency reaches the upper limit, for example, the process proceeds to S137, and the bubbling power (heating amount) as one of the conditions for driving the heating elements is increased. The method of increasing the bubbling power includes, for example, a method of increasing the voltage of the driving pulse applied to drive the heating element, a method of increasing the pulse width of the driving pulse applied to the heating element, and the like. After the bubbling power is increased, the process returns to S110, and the processing continues.

After a lapse of the target generation time, and if the determination result in S110 is YES, the process proceeds to S114, and the UFB generating processing is terminated. Thereafter, similar to the first embodiment, the processings of S114 to S116 are executed, the thus-generated UFB-containing liquid is discharged to the collecting unit 500, and a series of the processings of generating the UFB-containing liquid is terminated.

### Second Embodiment

Next, a second embodiment of the present invention is described. A UFB generating apparatus according to the second embodiment generates the UFB-containing liquid of the target generation amount having the target UFB concentration in the generation time by feeding back the change in the UFB generation speed to the generation speed.

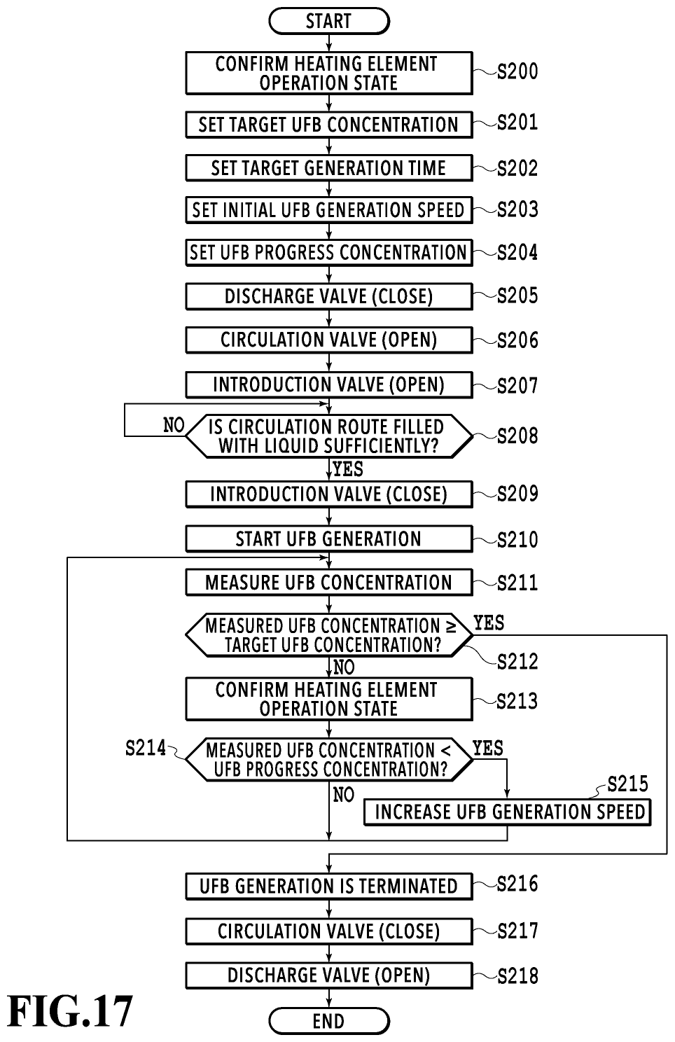

FIG. 17 is a flowchart showing the operations of generating the UFBs executed in the second embodiment. Processings of S200 to S203 in FIG. 17 are similar to the processings of S100 to S103 in FIG. 13. Additionally, processings of S213 and S216 to S218 are similar to the processings of S111 and S114 to S116 in FIG. 13. For this reason, the redundant descriptions of the processings in FIG. 17 similar to the processings in FIG. 13 are omitted.

In this embodiment, based on the initial UFB generation speed set in S203, the UFB progress concentration associated with the time (generation time) in which the UFBs are continuously generated from the start of the UFB generation is estimated and set (S204). The processing of estimating and setting the progress concentration is performed by the CPU 1001. Thus, the CPU 1001 functions as a progress concentration setting unit of the present invention.

In this embodiment, the UFB generation speed is set to 1.0e8 pieces/mL, and the estimated values of the UFB progress concentration in each generation time are shown in Table 2.

TABLE 2

| | UFB progress |
|---|---|
| elapsed time | concentration |
| 0 second | 0.00e8 piece/mL |
| 20 seconds | 0.20e8 pieces/mL |
| 40 seconds | 0.40e8 pieces/mL |
| 60 seconds | 0.60e8 pieces/mL |
| 80 seconds | 0.80e8 pieces/mL |
| 100 seconds | 1.00e8 pieces/mL |

Thereafter, processings of S205 to S210 are performed. The processings are similar to the processings of S104 to S109 in FIG. 13, and the descriptions are omitted.

Next, the UFB concentration of the UFB-containing liquid in the current UFB generating apparatus 1A is measured in S212. There are known a method of measuring the UFB concentration by calculating the number of the UFBs in optical manner using a magnifying glass and a camera and a method of measuring the UFB concentration by measuring the zeta potential (Z-potential) as a concentration measuring method for measuring the UFB concentration, and any of them may be used.

In S212, it is determined whether the measured UFB concentration measured in S211 reaches the concentration equal to or more than the target UFB concentration set in S201. If the determination result is YES, the process proceeds to S216, and the UFB generating processing is terminated. If the determination result is NO, the process proceeds to S213. In S213, similar to S111 in FIG. 13, the operation state of each heating element provided in the heating part 10G is confirmed.

In S214, it is determined whether the measured UFB concentration measured in S211 (measured concentration) is a concentration lower than the UFB progress concentration (the concentration set in S204), which is associated with the time in which the measured concentration is measured. If the determination result is YES, the process proceeds to S215, and the UFB generation speed is increased. The method of increasing the UFB generation speed is adding the number of the operating heating elements, increasing the drive frequency of each operating heating element, increasing the bubbling power of the heating element, or the like, for example, depending on the operation state of the heating elements confirmed in S213. Then, the process proceeds to the processing of measuring the UFB concentration (S211). Thereafter, the processings of S211 to S215 are repeated until the determination result in S212 becomes YES, or until the measured UFB concentration becomes equal to or more than the target UFB concentration, and the UFB generating processing is terminated at the time point when the determination result in S212 becomes YES (S216). After this, in S216 to S218, processings similar to the processings of S114 to S116 in the first embodiment are executed, the thus-generated UFB-containing liquid is discharged to the collecting unit 500, and a series of the processings of generating the UFB-containing liquid is terminated.

### Modification of Second Embodiment

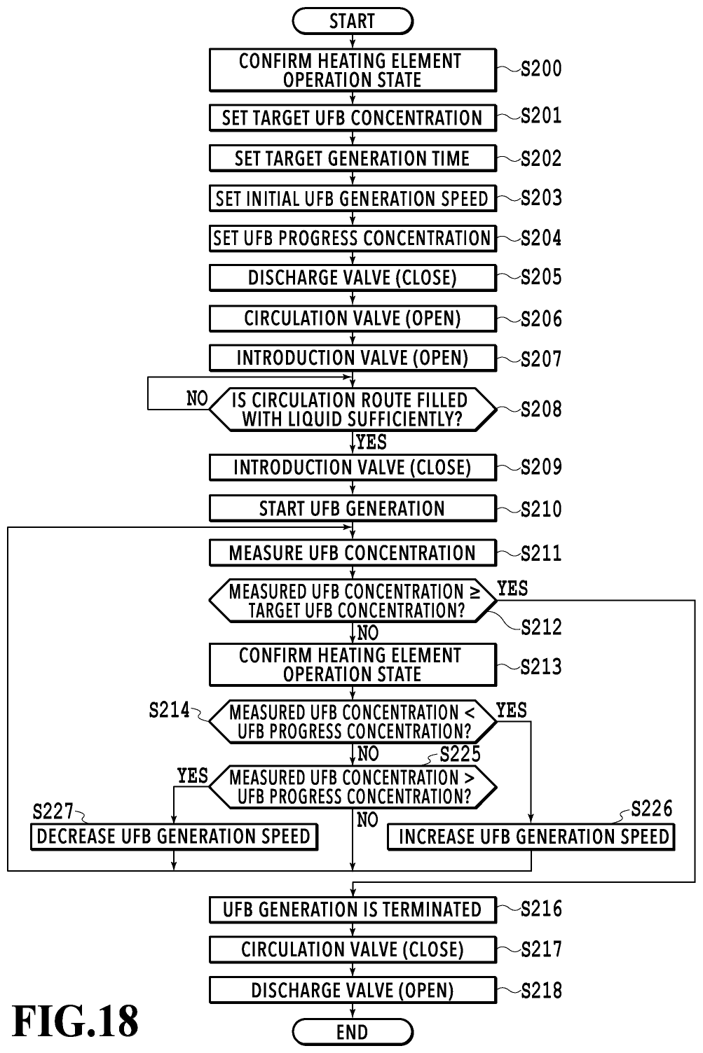

Next, a modification of the second embodiment is described. The above-described second embodiment illustrated in FIG. 17 shows the example where the UFB generation speed is increased in the case where the measured UFB concentration is lower than the UFB progress concentration. In contrast, in this modification, the UFB generation speed is increased similarly to the second embodiment illustrated in FIG. 17 in the case where the measured UFB concentration is lower than the UFB progress concentration, and the control for decreasing the UFB generation speed is performed in the case where the measured UFB concentration becomes higher than the UFB progress concentration. The increase and decrease of the UFB generation speed in accordance with the UFB progress concentration make it possible to generate the UFB-containing liquid of the target generation amount having the target UFB concentration more accurately. Hereinafter, the processing of generating the UFB-containing liquid executed in this modification is described with reference to the flowchart in FIG. 18. Processings of S200 to S213 in FIG. 18 are similar to the processings of S200 to S213 in FIG. 17, and the descriptions are omitted.

In FIG. 18, in S214, it is determined whether the UFB concentration measured in S211 does not reach the UFB progress concentration set in S204. If the determination result is YES, the process proceeds to S226 to increase the UFB generation speed, and the process proceeds to S211. The method of increasing the UFB generation speed is adding the number of the operating heating elements, increasing the drive frequency of each operating heating element, increasing the bubbling energy of the heating element, or the like, for example, based on the operation state of the heating elements confirmed in S213.

If the determination result in S214 is NO, or if the measured UFB concentration is equal to or more than the UFB progress concentration, the process proceeds to S225. In S225, it is determined whether the UFB concentration measured in S211 exceeds the UFB progress concentration set in S204. If the determination result is YES, the process proceeds to S227 to decrease the UFB generation speed, and then the process proceeds to S211. The method of decreasing the UFB generation speed is reducing the number of the operating heating elements, decreasing the drive frequency of each operating heating element, increasing the bubbling energy of the heating element, or the like, for example, depending on the operation state of the heating elements confirmed in S213.

Since the state where the determination result in S225 is NO means the state where the measured UFB concentration is equal to the estimated UFB concentration, the process proceeds to S211 without updating the UFB generation speed. Thereafter, the processings of S212, S211 to S214, and S225 to S226 are repeated until the determination result in S212 becomes YES, and at the time point when the determination result in S212 becomes YES, the UFB generating processing is terminated (S216).

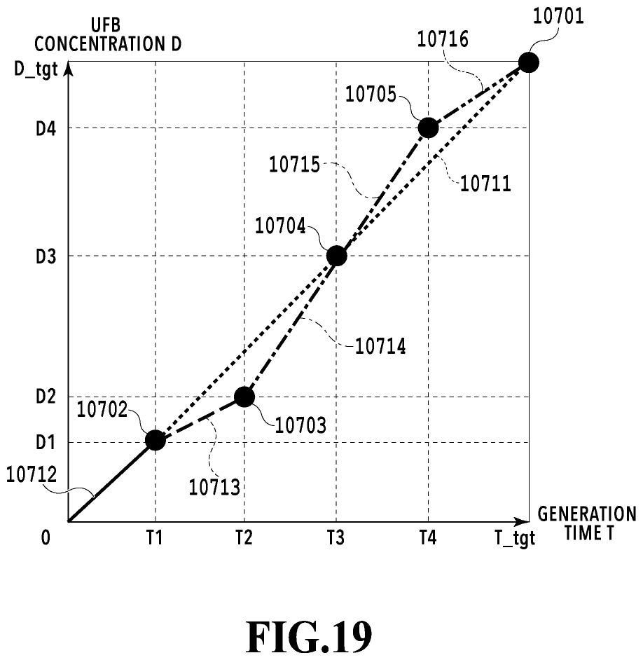

FIG. 19 is a diagram illustrating a relationship between a UFB generation elapsed time T and a generated UFB concentration D in the case where the UFB generation speed is controlled in accordance with the UFB concentration in this embodiment. A point 10701 illustrated in FIG. 19 indicates that the UFB concentration of the UFB-containing liquid to be generated is expected to reach the UFB concentration D_tgt (=1.0e8 pieces/mL) as the initial target in the estimated generation time T_tgt (=100 seconds). A dotted line 10711 illustrated in FIG. 19 indicates an initial estimated value of the increase of the UFB concentration over the lapse of the generation time.

An example where the UFB generation is performed from the start of generating the UFBs for 20 seconds (T1) as the initial expectation, a part of the heating elements 10 loses the heating functions after the lapse of 20 seconds, which causes the decrease of the UFB generation speed, and losing of the function of the heating elements 10 does not occur anymore thereafter is described.

A point 10702 illustrated in FIG. 19 indicates a UFB concentration D1 (=2.0e7 pieces/mL) after a lapse of a generation time T1 (=20 seconds). A solid line 10712 indicates an estimated value of the UFB concentration according to the generation time. The state of the heating elements being used in the moment corresponding to the solid line 10712 corresponds to the state illustrated in FIG. 20B.

A point 10703 illustrated in FIG. 19 indicates a UFB concentration D2 (=3.6e70,000 pieces/mL) at the time point after a lapse of a generation time T2 (=40 seconds), and a broken line 10713 indicates a measured value of the UFB concentration changing (increasing) over the generation time.

In this case, since the UFB concentration D2 is a value smaller than the UFB progress concentration (=4.0e70,000 pieces/mL) at the time point after the lapse of the generation time T2 (=40 seconds), the determination result in S214 is YES, and the UFB generation speed is increased in S226.

The increased amount of the UFB concentration in 20 seconds between the generation times T1 and T2 is 1.6e7 pieces/mL (=(3.6e7 pieces/mL)−(2.0e70,000 pieces/mL)). Based on this increased amount, it is estimated that the number of the heating elements that can be driven is about 80 million pieces.

In this embodiment, the UFB generation speed is increased by increasing the drive frequency of the heating element 10. The amount of the UFBs that are not generated yet at the time point after the lapse of the generation time T2 (=40 seconds) is about 4.0e6 pieces/mL ((4.0e7 pieces/mL)−(3.6e7 pieces/mL)). Based on this, 24 million pieces/mL (=(2.0e7 pieces/mL)+(4.0e6 pieces/mL)), which is the amount obtained by adding the shortage to the initially expected generation amount, of the UFBs are generated in the next generation time from T2 (40 seconds) to T3 (60 seconds). Thus, the drive frequency is increased 1.5 times, which is 15 kHz. A dashed-dotted line 10714 in FIG. 19 indicates a UFB concentration estimated value over the lapse of the generation time.

A point 10704 illustrated in FIG. 19 indicates a UFB concentration D3 (=6.0e7 pieces/mL) at a time point after a lapse of the generation time T3 (=60 seconds), and the dashed-dotted line 10714 in FIG. 19 indicates the UFB concentration estimated value over the lapse of the generation time. Since the UFB concentration D3 is equal to the value of the UFB progress concentration (=6.0e7 pieces/mL) at the time point after a lapse of the generation time T3 (=60 seconds), the determination results from the determination processing in S214 and S225 are both NO, and the processing continues with the UFB generation speed maintained. A dashed-dotted line 10715 in FIG. 19 indicates a UFB concentration estimated value increasing over the generation time.

Next, a point 10705 illustrated in FIG. 19 indicates a UFB concentration D4 (=8.4e7 pieces/mL) at the time point after a lapse of a generation time T4 (=80 seconds), and the dashed-dotted line 10715 indicates the UFB concentration estimated value increasing over the elapsed time.

The UFB concentration D4 in this case is a value greater than the UFB progress concentration (=8.0e7 pieces/mL) at a time point after a lapse of the elapsed time T4 (=80 seconds). Consequently, the determination result from the determination processing in S214 is NO, and the determination result from the determination processing in S225 is YES, and the UFB generation speed is decreased in S227. The processing is performed as described below.

The increased amount of the UFB concentration in 20 seconds between the generation times T3 and T4 is 2.4e7 pieces/mL (=(8.0e7 pieces/mL)−(6.0e7 pieces/mL)). Based on this increased amount, it is estimated that the number of the working heating elements is about 8.0e7 pieces.

In this embodiment, the processing of decreasing the UFB generation speed is performed by decreasing the drive frequency of the heating element 10. At the time point after the lapse of the generation time T4 (=80 seconds), the amount of the exceeded UFBs is about 4.0e6 pieces/mL (=(8.4e7 pieces/mL)−(8.0e7 pieces/mL)). Based on this, 1.6e7 pieces/mL(=(2.0e7 pieces/mL)−(4.0e6 pieces/mL), which is the amount obtained by subtracting the exceed from the initially expected generation amount, of the UFBs are generated in the next generation time from T4 (80 seconds) to T_tgt (100 seconds). Thus, the drive frequency of the heating element 10 is increased 1.0 time from the original drive frequency, which is 10 kHz. A dashed double-dotted line 10716 illustrated in FIG. 19 indicates a UFB concentration estimated value over the elapsed time.

With such a control, the UFB concentration estimated value eventually reaches the value indicated by the point 10701 in FIG. 19. The point 10701 indicates the UFB progress concentration D_tgt (=1.0e8 pieces/mL) in the target generation time T_tgt (100 seconds).

The method of controlling the UFB generation speed in accordance with the comparing result is described, the comparing result being obtained by comparing the UFB progress concentration set in S204 and the measured UFB concentration corresponding to the UFB progress concentration with each other to control with the drive frequency of the operating heating element changed. Note that a method of controlling the number of the operating heating elements may also be used as the method of controlling the UFB generation speed.

Hereinafter, the controlling method is described with reference to FIGS. 20B to 20F. The operation state of the initial heating elements is illustrated in FIG. 20B. The heating elements being operated are colored in black (heating elements of numbers 01 to 10) while the heating elements being not operated are colored in white (heating elements of numbers 11 to 16). That is, in the state illustrated in FIG. 20B, ten heating elements are in operation, and six heating elements are in the reserve state.

According to the broken line 10713 in FIG. 19, the measured UFB concentration (measured concentration) is lower than the UFB progress concentration. This indicates that there is a damaged heating element that lost the heating function among the heating elements being driven in the generation time from T1 to T2. The operation state of the heating elements in this case is illustrated in FIG. 20C. In FIG. 20C, since the two heating elements of numbers 01 and 02 are damaged and only the remaining eight operating heating elements are functioning, the UFB generation speed is decreased. Thus, in the case of such a situation, the processing of increasing the UFB generation speed is executed in S226. Specifically, the processing of adding the number of the driving heating elements is executed. FIG. 20D illustrates the state where the driving heating elements are added and the added driving heating elements are generating heat properly. In FIG. 20D, four operating heating elements of numbers 11 to 14 are further added, and the total number of the operating heating elements is 12. Thus, the UFB generation speed is increased, and the increase rate of the measured UFB concentration is increased as well as indicated by the dashed-dotted line 10714 in FIG. 19.

On the other hand, the measured concentration in the dashed-dotted line 10715 in FIG. 19 is higher than the UFB progress concentration. In such a case, the UFB generation speed is decreased by reducing the number of the operating heating elements. FIG. 20E illustrates the state where the number of the operating heating elements is reduced. In FIG. 20E, eight heating elements (heating elements of numbers 03 to 10) are in operation, and six heating elements (heating elements of numbers 11 to 16) are in the reserve state. Thus, it is possible to decrease the UFB generation speed by reducing the driving heating element. As a result, the increase rate of the measured UFB concentration is decreased as indicated by the dashed double-dotted line 10716, and the measured UFB concentration eventually reaches the value indicated by the point 10701 in FIG. 19. The point 10701 indicates the UFB progress concentration D_tgt (=1.0e8 pieces/mL) in the target generation time T_tgt (100 seconds).

The UFB generating processing is performed while controlling the generation speed as described above, and if the determination result in S212 becomes YES, the UFB generation is terminated in S216. Thereafter, the processings of S114 to S116 are executed and the thus-generated UFB-containing liquid is discharged to the collecting unit 500. With the above processing, a series of the processings of generating the UFB-containing liquid is terminated.

In the case where the generation speed is increased or decreased in S226 or S227, it is possible to use any of the above-described “controlling the number of the driving heating elements”, “controlling the drive frequency”, and “controlling the bubbling power” as necessary. Thus, although it is not particularly shown in the flowchart in FIG. 18, it is also possible to set at least one of the above three types of controls automatically or manually before the processing of increasing or decreasing the generation speed. In the case of setting the control method automatically, it is also possible to determine whether it is possible to increase or decrease the number of the operating heating elements or whether it is possible to increase or decrease the drive frequency like the second modification shown in FIG. 16 to select an executable control as necessary.

As described above, in the second embodiment and the modification thereof, the number of the operating heating elements and the drive frequency of the heating element are controlled dynamically based on the measured result of the UFB concentration. Consequently, it is possible to generate the UFBs of the target generation amount having the target concentration in the target UFB generation time more accurately.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-036529 filed Feb. 28, 2019, which is hereby incorporated by reference wherein in its entirety.

What is claimed is:

1. An ultrafine bubble generating apparatus, comprising:
a heating part that includes a heating element capable of heating a liquid;
a driving unit that drives the heating element to cause film boiling in the liquid to generate ultrafine bubbles;
a concentration setting unit that sets a target concentration of the ultrafine bubbles to be contained in the liquid;
a generation time setting unit that sets a target generation time required for generating a predetermined amount of the liquid having the target concentration; and
a controlling unit that controls the driving unit to adjust a generation speed of the ultrafine bubbles in accordance with the target concentration and the target generation time.

2. The ultrafine bubble generating apparatus according to claim 1, wherein
the controlling unit controls at least one of a drive frequency and a heating amount of the heating element driven by the driving unit.

3. The ultrafine bubble generating apparatus according to claim 1, wherein
the heating part includes a plurality of the heating elements, and
the controlling unit adjusts the number of the heating elements that are to be driven by the driving unit among the plurality of the heating elements.

4. The ultrafine bubble generating apparatus according to claim 1, wherein
the heating part includes a plurality of the heating elements,
the ultrafine bubble generating apparatus further includes an estimating unit that estimates the number of operating heating elements capable of generating the ultrafine bubbles among the heating elements that are to be driven by the driving unit, and
the controlling unit controls the driving unit based on the number of the operating heating elements estimated by the estimating unit.

5. The ultrafine bubble generating apparatus according to claim 4, wherein
the estimating unit estimates the number of the operating heating elements at least either before or after the driving of the heating elements.

6. The ultrafine bubble generating apparatus according to claim 5, wherein
the controlling unit controls the driving unit such that, in a case where the number of the operating heating elements estimated after the driving of the heating elements is smaller than the number of the operating heating elements estimated before the driving of the heating elements, any one of adding the number of the heating elements to be driven by the driving unit, increasing a drive frequency of each heating element, and increasing a heating amount of the heating element is executed.

7. The ultrafine bubble generating apparatus according to claim 1, further comprising:
a progress concentration setting unit that sets a progress concentration of the ultrafine bubbles associated with a generation time of the ultrafine bubbles based on the target concentration and the target generation time; and
a concentration measuring unit that measures a concentration of the ultrafine bubbles in the liquid after starting the generation of the ultrafine bubbles, wherein
the controlling unit controls the driving unit based on a measured concentration measured by the concentration measuring unit and the progress concentration corresponding to a time in which the measured concentration is measured.

8. The ultrafine bubble generating apparatus according to claim 7, wherein
the controlling unit controls the generation speed based on the measured concentration measured by the concentration measuring unit, the progress concentration corresponding to the time in which the measured concentration is measured, and the number of the operating heating elements estimated after the driving of the heating element.

9. The ultrafine bubble generating apparatus according to claim 7, wherein
in a case where the measured concentration is lower than the progress concentration corresponding to the measured concentration, the controlling unit controls the driving unit to increase the generation speed.

10. The ultrafine bubble generating apparatus according to claim 8, wherein
in a case where the measured concentration is lower than the progress concentration corresponding to the measured concentration, the controlling unit controls the driving unit to increase the generation speed.

11. The ultrafine bubble generating apparatus according to claim 9, wherein
in a case where the measured concentration is higher than the progress concentration corresponding to the measured concentration, the controlling unit controls the driving unit to decrease the generation speed.

12. The ultrafine bubble generating apparatus according to claim 10, wherein
in a case where the measured concentration is higher than the progress concentration corresponding to the measured concentration, the controlling unit controls the driving unit to decrease the generation speed.

13. An ultrafine bubble generating method, comprising:
setting a target concentration of ultrafine bubbles to be contained in a liquid;
setting a target generation time required for generating a predetermined amount of the liquid having the target concentration;
driving a heating element capable of heating the liquid to cause film boiling in the liquid to generate ultrafine bubbles; and
controlling the driving to adjust a generation speed of the ultrafine bubbles in accordance with the target concentration and the target generation time.

14. An ultrafine bubble-containing liquid containing the ultrafine bubbles generated by an ultrafine bubble generating apparatus, the apparatus comprising:
a heating part that includes a heating element capable of heating a liquid;
a driving unit that drives the heating element to cause film boiling in the liquid to generate ultrafine bubbles;
a concentration setting unit that sets a target concentration of the ultrafine bubbles to be contained in the liquid;
a generation time setting unit that sets a target generation time required for generating a predetermined amount of the liquid having the target concentration; and
a controlling unit that controls the driving unit to adjust a generation speed of the ultrafine bubbles in accordance with the target concentration and the target generation time.
